(19) United States
(12) Patent Application Publication
(10) Pub. No.: US 2025/0126434 A1
(43) Pub. Date: Apr. 17, 2025

(54) TERMINAL SELECTION METHOD AND APPARATUS, AND COMMUNICATIONS DEVICE

(71) Applicant: GUANGDONG OPPO MOBILE TELECOMMUNICATIONS CORP., LTD., Dongguan (CN)

(72) Inventors: Jingran CHEN, Dongguan (CN); Fei LU, Dongguan (CN)

(21) Appl. No.: 18/999,858

(22) Filed: Dec. 23, 2024

Related U.S. Application Data
(63) Continuation of application No. PCT/CN2022/103721, filed on Jul. 4, 2022.

(51) Int. Cl. H04W 4/02; H04W 64/00; H04W 88/02

(52) U.S. Cl. CPC H04W 4/023; H04W 64/00; H04W 88/02

(57) ABSTRACT

Embodiments of this application provide a terminal selection method and apparatus, and a communications device. The method includes: receiving, by a first node, a first request message sent by a second node, where the first request message includes a terminal selection policy, and the first request message is used to trigger a first terminal to perform ranging processes for a plurality of terminals, to obtain ranging results corresponding to the plurality of terminals; selecting, by the first node, at least one terminal from the plurality of terminals based on the ranging results corresponding to the plurality of terminals and the terminal selection policy; and sending, by the first node, a first request reply message to the second node, where the first request reply message includes a terminal identity of the at least one terminal.

### CROSS-REFERENCE TO RELATED APPLICATIONS

This application is a continuation of International Application No. PCT/CN2022/103721, filed on Jul. 4, 2022, the disclosure of which is hereby incorporated by reference in its entirety.

### TECHNICAL FIELD

Embodiments of this application relate to the field of mobile communications technologies, and specifically, to a terminal selection method and apparatus, and a communications device.

### BACKGROUND

When a third party wants to identify related information of a terminal (hereinafter referred to as a terminal A for ease of description), the third party needs to cooperate with other terminals near the terminal A to collect information of the terminal A in different directions from the other terminals near the terminal A.

Before collecting data from the other terminals, the third party needs to ensure that the other terminals are near the terminal A and the other terminals are located in different directions from the terminal A. To this end, the third party needs to select a suitable terminal to collect data. This requirement may be met through ranging and/or angle of arrival (AoA) technology. However, there is currently no solution discussing how to use the ranging technology to select a terminal.

### SUMMARY

Embodiments of this application provide a terminal selection method and apparatus, a communications device, a chip, a computer-readable storage medium, a computer program product, and a computer program.

The terminal selection method provided in embodiments of this application includes: receiving, by a first node, a first request message sent by a second node, where the first request message includes a terminal selection policy, and the first request message is used to trigger a first terminal to perform ranging processes for a plurality of terminals, to obtain ranging results corresponding to the plurality of terminals; selecting, by the first node, at least one terminal from the plurality of terminals based on the ranging results corresponding to the plurality of terminals and the terminal selection policy; and sending, by the first node, a first request reply message to the second node, where the first request reply message includes a terminal identity of the at least one terminal.

The terminal selection method provided in embodiments of this application includes: sending, by a second node, a first request message to a first node, where the first request message includes a terminal selection policy, the first request message is used to trigger a first terminal to perform ranging processes for a plurality of terminals, to obtain ranging results corresponding to the plurality of terminals, and the terminal selection policy is used by the first node to select at least one terminal from the plurality of terminals based on the ranging results corresponding to the plurality of terminals; and receiving, by the second node, a first request reply message sent by the first node, where the first request reply message includes a terminal identity of the at least one terminal.

The terminal selection apparatus provided in embodiments of this application is applied to a first node, and the apparatus includes: a communications unit, configured to receive a first request message sent by a second node, where the first request message includes a terminal selection policy, and the first request message is used to trigger a first terminal to perform ranging processes for a plurality of terminals, to obtain ranging results corresponding to the plurality of terminals; and a selection unit, configured to select at least one terminal from the plurality of terminals based on the ranging results corresponding to the plurality of terminals and the terminal selection policy, where the communications unit is further configured to send a first request reply message to the second node, where the first request reply message includes a terminal identity of the at least one terminal.

The terminal selection apparatus provided in embodiments of this application is applied to a second node, and the apparatus includes: a communications unit, configured to: send a first request message to a first node, where the first request message includes a terminal selection policy, the first request message is used to trigger a first terminal to perform ranging processes for a plurality of terminals, to obtain ranging results corresponding to the plurality of terminals, and the terminal selection policy is used by the first node to select at least one terminal from the plurality of terminals based on the ranging results corresponding to the plurality of terminals; and receive a first request reply message sent by the first node, where the first request reply message includes a terminal identity of the at least one terminal.

The communications device provided in embodiments of this application includes a processor and a memory. The memory is configured to store a computer program, and the processor is configured to invoke and run the computer program stored in the memory, to perform the foregoing terminal selection method.

The chip provided in embodiments of this application is configured to implement the foregoing terminal selection method.

Specifically, the chip includes a processor, configured to invoke a computer program from a memory and run the computer program, to cause a device on which the chip is installed to perform the foregoing terminal selection method.

The computer-readable storage medium provided in embodiments of this application is configured to store a computer program, and the computer program causes a computer to perform the foregoing terminal selection method.

The computer program product provided in embodiments of this application includes computer program instructions, and the computer program instructions cause a computer to perform the foregoing terminal selection method.

The computer program provided in embodiments of this application, when run on a computer, causes the computer to perform the foregoing terminal selection method.

According to the foregoing technical solutions, a new terminal selection policy is introduced. The second node as a third party may send the terminal selection policy to the first node. The first node triggers the first terminal to perform the ranging processes for the plurality of terminals, to obtain the ranging results corresponding to the plurality of terminals, selects at least one terminal from the plurality of terminals based on the terminal selection policy and the ranging results corresponding to the plurality of terminals, and sends the terminal identity of the at least one selected terminal to the second node.

### BRIEF DESCRIPTION OF DRAWINGS

The accompanying drawings described herein are used to provide a further understanding of this application, and constitute a part of this application. A schematic embodiment of this application and descriptions thereof are used to explain this application, and do not constitute an improper limitation on this application. In the accompanying drawings:

FIG. 1 is a schematic diagram of federated inference.

FIG. 2 is a schematic diagram of a UE-to-network (U2N) relay.

FIG. 3 is a schematic diagram of a UE-to-UE (U2U) relay.

FIG. 4 is a schematic diagram in which a ranging result between UE1 and UE2 is exposed to third party UE.

FIG. 5 is a schematic flowchart 1 of a terminal selection method according to an embodiment of this application.

FIG. 6 is a schematic flowchart 2 of a terminal selection method according to an embodiment of this application.

FIG. 7 is a schematic flowchart 3 of a terminal selection method according to an embodiment of this application.

FIG. 8 is a schematic diagram 1 of a structure of a terminal selection apparatus according to an embodiment of this application.

FIG. 9 is a schematic diagram 2 of a structure of a terminal selection apparatus according to an embodiment of this application.

FIG. 10 is a schematic structural diagram of a communications device according to an embodiment of this application.

FIG. 11 is a schematic diagram of a structure of a chip according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. Based on embodiments of this application, all other embodiments obtained by a person of ordinary skill in the art without creative efforts fall within the protection scope of this application.

It should be noted that the term “and/or” in this specification describes merely an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects. It should be further understood that, the “indication” mentioned in embodiments of this application may be a direct indication or an indirect indication, or indicate an association relationship. For example, A indicates B, which may mean that A directly indicates B, for example, B can be obtained by means of A; or may mean that A indirectly indicates B, for example, A indicates C, and B can be obtained by means of C; or may mean that there is an association relationship between A and B. It should be further understood that the term “corresponding” mentioned in embodiments of this application may mean that there is a direct or indirect correspondence between two elements, or that there is an association relationship between two elements, or that there is a relationship of “indicating” and “being indicated”, “configuring” and “being configured”, or the like.

To facilitate understanding of the technical solutions in embodiments of this application, the following describes related technologies in embodiments of this application. The following related technologies, as optional solutions, may be randomly combined with the technical solutions of embodiments of this application, all of which fall within the protection scope of embodiments of this application.

### Federated Inference/Distributed Inference

In a scenario, when a vehicle wants to obtain related information (such as a position, a width, a length, a height, an outline, and an orientation) about a specific vehicle in front of it, data collected by the vehicle itself is finite. For example, a vehicle can only obtain related data of the rear of the vehicle in front through a sensor. Through inference by a locally amounted artificial intelligence (AI) model, the vehicle directly behind can identify information such as a width and a height of the vehicle in front, but cannot know a length of the vehicle in front or even a more precise outline of the entire vehicle. In addition, although a position of a vehicle in front can be known through a radar and another device of a single vehicle, accuracy of positioning based on information obtained by the single vehicle is limited due to monotony of data. All of the foregoing problems need to be resolved through federated inference.

In another scenario, when a traffic accident, for example, a rear-end collision, occurs somewhere, a jam is caused. A vehicle or a third party server wants to know a whole situation at the traffic accident scene so as to plan a driving trajectory of the vehicle in real time. Therefore, the vehicle or the server needs to find and establish connections to vehicles in different directions near a vehicle to which the traffic accident occurs, collect data from different directions of the traffic accident scene, and therefore, completely reproduce the traffic accident scene. This scenario also needs to be implemented through federated inference.

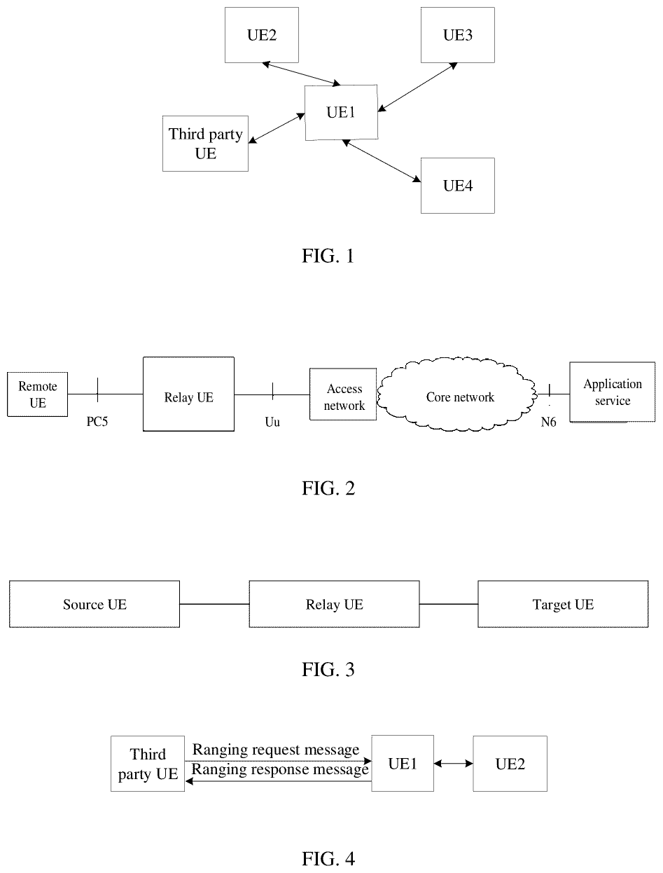

The federated inference is shown in FIG. 1. When third party UE wants to identify related information about UE1, the third party UE needs to cooperate with other UEs near the UE1 (such as UE2, UE3, and UE4), and the other UEs are located in different directions of the UE1, so as to collect information from the different directions of the UE1. The other UEs can feed back inference results for the UE1 to the third party UE through a local model. The third party UE aggregates a plurality of results to obtain richer and more accurate information about the UE1. Alternatively, the other UEs may send collected data related to the UE1 to the third party UE. The third party UE aggregates multi-source data to obtain richer data samples and perform local inference to obtain a more accurate result.

### Prose Architecture

UE having a proximity based services (Prose) capability can communicate directly with another UE having a Prose capability through a PC5 interface.

When UE can be connected to an external data network through a 5G network and has the Prose capability, this UE can function as relay UE. Another remote UE having the Prose capability can establish a direct connection to the relay UE through the PC5 interface, and then the relay UE establishes a PDU session with the 5G network to interact with the external network. This is shown in FIG. 2.

In addition, when two UEs having Prose capabilities are far apart and cannot directly establish communication through a PC5 interface, the two UEs may further use relay UE having a Prose capability to relay the communication. As shown in FIG. 3, relay UE can directly communicate with source UE through a PC5 interface, and may further directly communicate with target UE through the PC5 interface, and service interaction can be performed between the source UE and the target UE through relay UE.

### Ranging

Ranging is a newly established research project. Ranging refers to determining a distance between two or more terminals and/or a direction of and/or a relative position between one terminal (namely, a target terminal) and another terminal (namely, a reference terminal) through a PC5 interface. One direction of the ranging research project is to study exposure of a ranging result between UEs to third party UE or a third party server. As shown in FIG. 4, for example, third party UE may be connected to UE1. The third party UE sends a ranging request to the UE1 to request ranging information between the UE1 and UE2, a ranging process is performed between the UE1 and the UE2, and the UE1 calculates a ranging result based on measurement data obtained in the ranging process, and sends the ranging result to the third party UE through a ranging response.

When federated inference is used, before collecting data of other UEs, the third party UE or the third party server needs to ensure that the other UEs are located near reference UE (such as the UE1 in FIG. 1), and the other UEs need to be located in different directions from the reference UE. This requirement may be met by ranging. Currently, there is no solution discussing how to use the ranging technology to meet the requirement of the federated inference. In addition, before the third party UE wants to perform inference, if the manner described in FIG. 4 is used, the third party UE requests a ranging result from the UE1 to select suitable UE to collect data. Then, the UE1 needs to send ranging results of all nearby UEs relative to the UE1 to the third party UE. Because there are many other UEs near the UE1, large interaction overheads may be generated between the third party UE and the UE1. In addition, exposure of a large quantity of ranging results to third party UE may further cause security problems. A similar problem also occurs when a third party server requests a ranging result. When the third party server requests a ranging result through a core network, large interaction overheads and a large quantity of security problems may be generated between the core network and the server. Therefore, the following technical solutions in embodiments of this application are proposed.

It should be noted that the technical solutions in embodiments of this application may not be limited to being applied to a 5G system.

It should be noted that a “first core network element” described in the technical solutions in embodiments of this application may be a new network element or an existing network element (a function of an existing network element needs to be enhanced to implement a function of the first core network element). As an example, the existing network element may be a network exposure function (NEF) network element.

It should be noted that a “terminal” described in the technical solutions of embodiments of this application may be a terminal of any type, such as a mobile phone, a vehicle-mounted terminal, a smart home device, or a wearable device. Description of the “terminal” may alternatively be replaced by description of “user equipment (UE)”.

For ease of understanding of the technical solutions in embodiments of this application, the technical solutions of this application are described in detail below by using specific embodiments. The foregoing related technologies, as optional solutions, may be randomly combined with the technical solutions in embodiments of this application, all of which fall within the protection scope of embodiments of this application. Embodiments of this application include at least part of the following content.

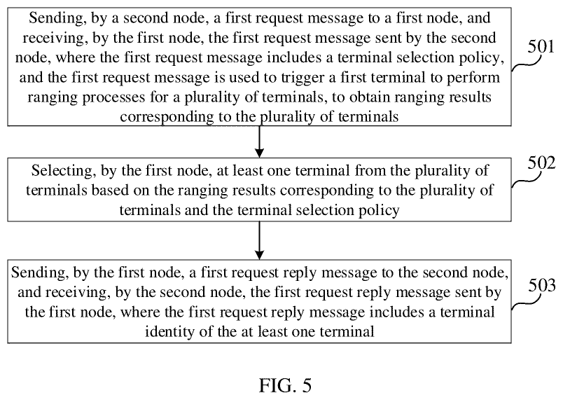

FIG. 5 is a schematic flowchart of a terminal selection method according to an embodiment of this application. As shown in FIG. 5, the terminal selection method includes the following steps.

Step 501: a second node sends a first request message to a first node, and receives the first request message sent by the second node, where the first request message includes a terminal selection policy, and the first request message is used to trigger a first terminal to perform ranging processes for a plurality of terminals, to obtain ranging results corresponding to the plurality of terminals.

Step 502: the first node selects at least one terminal from the plurality of terminals based on the ranging results corresponding to the plurality of terminals and the terminal selection policy.

Step 503: the first node sends a first request reply message to the second node, and the second node receives the first request reply message sent by the first node, where the first request reply message includes a terminal identity of the at least one terminal.

In this embodiment of this application, a name of the first request message may be a terminal selection request message. Certainly, the first request message may alternatively have another name, and this application does not limit the name of the first request message.

In this embodiment of this application, a name of the first request reply message may be a terminal selection request reply message. Certainly, the first request reply message may alternatively have another name, and this application does not limit the name of the first request reply message.

In this embodiment of this application, the second node sends the first request message to the first node, and correspondingly, the first node receives the first request message sent by the second node. The first request message is used to trigger a first terminal to perform ranging processes for a plurality of terminals, to obtain ranging results corresponding to the plurality of terminals. The first request message carries the terminal selection policy, and the first node selects the at least one terminal from the plurality of terminals based on the ranging results corresponding to the plurality of terminals and the terminal selection policy. The first node sends the first request reply message to the second node, and correspondingly, the second node receives the first request reply message sent by the first node, where the first request reply message includes the terminal identity of the at least one terminal.

In this embodiment of this application, the first node is the first terminal or a first core network element, and the second node is a third party terminal or a third party server. The following describes the technical solutions in embodiments of this application with reference to specific implementations of the first node and the second node.

Solution 1: The first node is the first terminal, and the second node is the third party terminal.

The sending, by a second node, a first request message to a first node is: sending, by the third party terminal, a first request message to the first terminal; and the receiving, by the first node, the first request message sent by the second node is: receiving, by the first terminal, the first request message sent by the third party terminal.

The sending, by the first node, a first request reply message to the second node is: sending, by the first terminal, a first request reply message to the third party terminal. The receiving, by the second node, the first request reply message sent by the first node is: receiving, by the third party terminal, the first request reply message sent by the first terminal.

In some implementations, before the third party terminal sends the first request message to the first terminal, the third party terminal establishes a connection to the first terminal. In other words, before the first terminal receives the first request message sent by the third party terminal, the first terminal establishes a connection to the third party terminal.

Herein, that the third party terminal establishes a connection to the first terminal (or that the first terminal establishes a connection to the third party terminal) may be implemented in the following manner. The first terminal broadcasts a second discovery message, and the third party terminal receives the second discovery message broadcast by the first terminal, where the second discovery message includes second indication information and/or a first parameter, the second indication information is used to indicate that the first terminal supports ranging, and the first parameter includes a terminal identity list that is used to indicate a list of terminals on which the first terminal is configured to perform a ranging process.

The third party terminal selects the first terminal based on the second discovery message and requests establishment of a connection to the first terminal, and the first terminal accepts, based on the second discovery message, the connection establishment requested by the third party terminal.

In some implementations, after the first terminal receives the first request message sent by the third party terminal, the first terminal determines ranging service requirement information based on the first request message, and the first terminal performs ranging processes for a plurality of terminals based on the ranging service requirement information, to obtain ranging results corresponding to the plurality of terminals.

Herein, optionally, the ranging service requirement information includes at least one of following: a measurement distance, a measurement direction, or measurement accuracy.

Herein, optionally, the ranging results include at least one of following: a distance of a terminal relative to the first terminal, or a direction of the terminal relative to the first terminal.

Herein, the plurality of terminals may include two terminals or a greater quantity of terminals. A second terminal in the plurality of terminals is used as an example. When the first terminal performs a ranging process for the second terminal, the first terminal serves as a reference terminal and the second terminal serves as a target terminal. The first terminal measures a reference signal of the second terminal, and calculates a distance of the second terminal relative to the first terminal and/or a direction of the second terminal relative to the first terminal (namely, a ranging result corresponding to the second terminal) based on measurement data of the reference signal. Similarly, the first terminal performs the ranging processes for the plurality of terminals, so that the ranging results corresponding to the plurality of terminals may be obtained.

In some implementations, the first request message further includes an application identity, the application identity is used by the first terminal to determine a plurality of terminals each having a target application, and the application identity is used to identify the target application. Before the first terminal performs the ranging processes for the plurality of terminals based on the ranging service requirement information, the first terminal determines, based on the application identity, a plurality of terminals each having a target application, where the application identity is used to identify the target application. The first terminal establishes connections to the plurality of terminals. Then, the first terminal performs the ranging processes for the plurality of terminals to which the connections are established.

Here, as an implementation, that the first terminal determines, based on the application identity, a plurality of terminals each having a target application may be implemented in the following manner. The first terminal broadcasts a first discovery message, where the first discovery message includes the application identity. The first terminal determines, based on a received first response message, a plurality of terminals each having the target application, where the first response message is sent, after the first discovery message is received, by a terminal having the target application identified by the application identity.

Herein, the application identity may include at least one of the following: an App ID, a model identity (model ID), or Prose application code.

In this embodiment of this application, after obtaining the ranging results corresponding to the plurality of terminals, the first terminal selects the at least one terminal from the plurality of terminals based on the ranging results corresponding to the plurality of terminals and the terminal selection policy.

In some implementations, the terminal selection policy includes at least one of the following: a first selection policy, where the first selection policy is used to indicate selection of a terminal whose distance from the first terminal is less than or equal to a first distance threshold; a second selection policy, where the second selection policy is used to indicate at least one of the following: selection of terminals located in different directions of the first terminal, or selection of terminals located in a plurality of directions specified by the first terminal; or a third selection policy, where the third selection policy is used to indicate at least one of the following: a quantity of selected terminals, or a quantity of selected terminals being less than or equal to a first quantity threshold and/or greater than or equal to a second quantity threshold.

Optionally, if the terminal selection policy includes at least two selection policies, the at least two selection policies may have different priorities. For example, the terminal selection policy includes a first selection policy and a third selection policy, and a priority of the first selection policy is higher than a priority of the third selection policy. In this case, when the first terminal performs terminal selection, the first selection policy first needs to be met, and then the third selection policy needs to be met.

In this embodiment of this application, after selecting the at least one terminal from the plurality of terminals, the first terminal sends the first request reply message to the third party terminal, and the first request reply message includes the terminal identity of the at least one terminal.

In some implementations, the first request reply message further includes first indication information and/or a connection parameter of the at least one terminal, the first indication information is used to indicate that the first terminal is configured to function as a relay terminal, and the connection parameter of the at least one terminal is used for relay communication between the third party terminal and the at least one terminal. Optionally, the first request reply message further includes relay service code (RSC), where the RSC is used to identify a connection service provided by the relay terminal (namely, the first terminal).

Herein, since the first terminal has established connections to the third party terminal and the plurality of terminals, if the first terminal can function as a relay terminal and has been authorized to function as a relay terminal, the first terminal may include the first indication information and/or the connection parameter of the at least one terminal in the first request reply message, the first indication information is used to indicate that the first terminal is configured to function as a relay terminal, and the connection parameter of the at least one terminal is used for relay communication between the third party terminal and the at least one terminal.

Herein, the connection parameter of the at least one terminal may include at least one of the following: a user information identity (User info ID) or a layer-2 identity (layer-2 ID). Here, the user info ID and layer-2 ID are used to ensure that the third party terminal can know related information of a target terminal to which connection establishment is to be initiated.

It should be noted that the information including RSC, user info ID, and layer-2 ID is used to let the third party terminal know related information of the relay terminal (that is, the first terminal) and the target terminal (that is, the at least one terminal), so that there is no need to perform a discovery process again, and an established connection can be directly used for relay communication.

Further, in some implementations, after obtaining the identity of the at least one terminal, the third party terminal communicates with the at least one terminal based on the identity of the at least one terminal (may be relay communication through the first terminal), thereby implementing federated inference. FIG. 1 is used as an example. After obtaining the UE identities of other UEs (such as the UE2, the UE3, and the UE4) near the UE1, the third party UE communicates with the other UEs, so as to collect information from different directions of the UE1 and obtain richer and more accurate information about the UE1.

Solution 2: The first node is the first core network element, and the second node is the third party server.

The sending, by a second node, a first request message to a first node is: sending, by the third party server, a first request message to the first core network element; and the receiving, by the first node, the first request message sent by the second node is: receiving, by the first core network element, the first request message sent by the third party server.

The sending, by the first node, a first request reply message to the second node is: sending, by the first core network element, a first request reply message to the third party server. The receiving, by the second node, a first request reply message sent by the first node is: receiving, by the third party server, a first request reply message sent by the first core network element.

In some implementations, after the first core network element receives the first request message sent by the third party server, the first core network element determines ranging service requirement information based on the first request message. The first core network element directly or indirectly sends a ranging request message to the first terminal, where the ranging request message includes the ranging service requirement information, and the ranging service requirement information is used to trigger the first terminal to perform the ranging processes for the plurality of terminals, to obtain the ranging results corresponding to the plurality of terminals. The first core network element directly or indirectly receives a ranging request reply message sent by the first terminal, where the ranging request reply message includes the ranging results corresponding to the plurality of terminals.

Optionally, the first request message further includes first identity information and/or second identity information, and the ranging request message further includes first identity information and/or second identity information; the first identity information is used to identify that a reference terminal for performing the ranging processes is the first terminal; and the second identity information is used to identify that target terminals on which the ranging processes are performed are the plurality of terminals. As an implementation, the first identity information is a terminal identity of the first terminal. As an implementation, the second identity information includes terminal identities of the plurality of terminals; or the second identity information is a group identity corresponding to the plurality of terminals. Herein, the plurality of terminals identified by the second identity information have a target application.

Herein, optionally, the ranging service requirement information includes at least one of following: a measurement distance, a measurement direction, or measurement accuracy.

Herein, optionally, the ranging results include at least one of following: a distance of a terminal relative to the first terminal, or a direction of the terminal relative to the first terminal.

Herein, the plurality of terminals may include two terminals or a greater quantity of terminals. A second terminal in the plurality of terminals is used as an example. When the first terminal performs a ranging process for the second terminal, the first terminal serves as a reference terminal and the second terminal serves as a target terminal. The first terminal measures a reference signal of the second terminal, and calculates a distance of the second terminal relative to the first terminal and/or a direction of the second terminal relative to the first terminal (namely, a ranging result corresponding to the second terminal) based on measurement data of the reference signal. Similarly, the first terminal performs the ranging processes for the plurality of terminals, so that the ranging results corresponding to the plurality of terminals may be obtained.

In the foregoing solution, that the first core network element indirectly sends a ranging request message to the first terminal includes: indirectly sending, by the first core network element, the ranging request message to the first terminal via forwarding by a second core network element; and that the first core network element indirectly receives a ranging request reply message sent by the first terminal includes: indirectly receiving, by the first core network element, the ranging request reply message from the first terminal and forwarded by the second core network element. Herein, as an example, the second core network element may be an access and mobility management function (AMF).

In this embodiment of this application, after obtaining the ranging results corresponding to the plurality of terminals, the first core network element selects the at least one terminal from the plurality of terminals based on the ranging results corresponding to the plurality of terminals and the terminal selection policy.

In some implementations, the terminal selection policy includes at least one of the following: a first selection policy, where the first selection policy is used to indicate selection of a terminal whose distance from the first terminal is less than or equal to a first distance threshold; a second selection policy, where the second selection policy is used to indicate at least one of the following: selection of terminals located in different directions of the first terminal, or selection of terminals located in a plurality of directions specified by the first terminal; or a third selection policy, where the third selection policy is used to indicate at least one of the following: a quantity of selected terminals, or a quantity of selected terminals being less than or equal to a first quantity threshold and/or greater than or equal to a second quantity threshold.

Optionally, if the terminal selection policy includes at least two selection policies, the at least two selection policies may have different priorities. For example, the terminal selection policy includes a first selection policy and a third selection policy, and a priority of the first selection policy is higher than a priority of the third selection policy. In this case, when the first terminal performs terminal selection, the first selection policy first needs to be met, and then the third selection policy needs to be met.

In this embodiment of this application, after selecting the at least one terminal from the plurality of terminals, the first core network element sends the first request reply message to the third party server, and the first request reply message includes the terminal identity of the at least one terminal.

It should be noted that interaction between the third party server and the first core network element in the foregoing solution is implemented through an application function (AF) corresponding to the third party server, that is, the interaction between the third party server and the first core network element may be understood as interaction between the AF corresponding to the third party server and the first core network element. Therefore, description of the “third party server” in the foregoing solution may alternatively be replaced by description of the “AF corresponding to the third party server, or directly referred to as AF”.

Further, in some implementations, after obtaining the identity of the at least one terminal, the third party server communicates with the at least one terminal based on the identity of the at least one terminal, thereby implementing federated inference.

In the technical solution of this embodiment of this application, terminal selection is implemented based on ranging. A new terminal selection policy is introduced, the third party terminal or the third party server (namely, a requesting party) may send the terminal selection policy to the first terminal or the first core network element (namely, a replying party). The first terminal or the first core network element generates ranging service requirement information based on the terminal selection policy, and guides the first terminal to perform ranging processes for a plurality of terminals, to obtain ranging results corresponding to the plurality of terminals. The first terminal or the first core network element selects at least one terminal based on the terminal selection policy and the ranging results corresponding to the plurality of terminals, and sends a terminal identity of the at least one selected terminal to the third party terminal or the third party server. In this way, a large amount of signaling interaction between the requesting party and the replying party can be avoided. The replying party only needs to reply with the terminal identity and does not need to reply with a specific ranging result, which reduces an amount of exchanged data and protects security of the ranging result. In implementation of the technical solution of this embodiment of this application, the ranging technology may be used to meet requirements in a federated inference scenario, reflecting an auxiliary role of a 3GPP system in supporting the federated inference services and promoting efficient execution of the federated inference services.

The following describes the technical solutions in embodiments of this application by using specific application instances. In the following application instance, the first request message is described as a terminal selection request message, and the first request reply message is described as a terminal selection request reply message. Certainly, these names are only used for illustration, and do not limit the solution of this application.

### Application Instance 1

This application instance describes a complete process in which a third party terminal selects other terminals located near a terminal 1 in different directions, and the complete process generally includes the following two stages.

Stage 1: The third party terminal sends a terminal selection request message to the terminal 1, where the terminal selection request message includes a terminal selection policy. After receiving the terminal selection request message, the terminal 1 maps the terminal selection request message into ranging service requirement information, performs ranging processes for surrounding terminals based on the ranging service requirement information, and obtains ranging results corresponding to the surrounding terminals (such as positions and/or directions of the surrounding terminals relative to the terminal 1). The terminal 1 selects at least one terminal based on the terminal selection policy and the ranging results corresponding to the surrounding terminals, and feeds back a terminal identity of the at least one selected terminal to the third party terminal through a terminal selection request reply message. In addition, because the terminal 1 has established connections to the surrounding terminals when the terminal 1 performs the ranging processes for the surrounding terminals, the terminal 1 may further include indication information in the terminal selection request reply message replied to the third party terminal to indicate that the terminal 1 can function as a relay terminal, may further include RSC in the terminal selection request reply message to identify a relay connection service provided by the terminal 1, and may further include connection parameters of the surrounding terminals (such as a user info ID and a layer-2 ID) in the terminal selection request reply message to help the third party terminal communicate with the surrounding terminals.

Stage 2: the third party terminal performs relay communication with the at least one selected terminal through the terminal 1, and collects information about the UE1 from the at least one terminal.

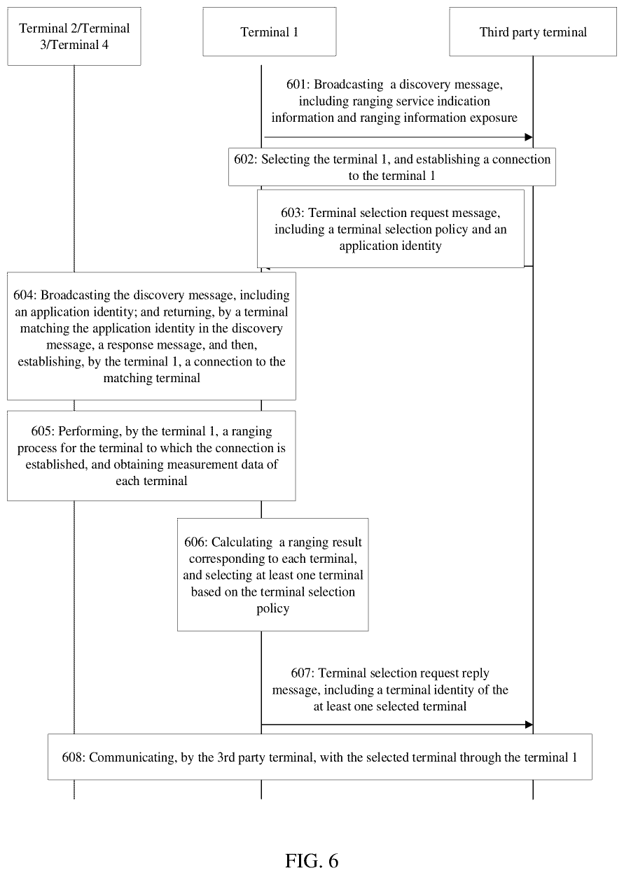

FIG. 6 shows a specific process of this application instance, and the specific process includes the following steps.

Step 601: the terminal 1 broadcasts a discovery message, where the discovery message includes ranging service indication information and ranging information exposure.

Herein, if there is no connection between the third party terminal and the terminal 1, the terminal 1 may periodically broadcast a discovery message, where the discovery message includes ranging service indication information (namely, the second indication information in the foregoing solution) used to indicate that the terminal 1 supports ranging. Optionally, the discovery message may further include ranging information exposure (namely, the first parameter in the foregoing solution), and the parameter includes a series of terminal identities (namely, a terminal identity list) used to indicate a series of terminals (namely, a terminal list) on which the terminal 1 can perform ranging processes.

Step 602: the third party terminal receives the discovery message, selects the terminal 1, and establishes a connection to the terminal 1.

Herein, the connection established between the third party terminal and the terminal 1 is a direct communication link.

Step 603: the third party terminal sends a terminal selection request message to the terminal 1, where the terminal selection request message includes a terminal selection policy and an application identity.

Herein, the terminal selection request message may be a new message, or may be a ranging request message.

The terminal selection request message includes the terminal selection policy, and the terminal selection policy includes at least one of the following: a first selection policy, where the first selection policy is used to indicate selection of a terminal whose distance from the terminal 1 is less than or equal to a first distance threshold; a second selection policy, where the second selection policy is used to indicate at least one of the following: selection of terminals located in different directions of the terminal 1, or selection of terminals located in a plurality of directions specified by the terminal 1; or a third selection policy, where the third selection policy is used to indicate at least one of the following: a quantity of selected terminals, or a quantity of selected terminals being less than or equal to a first quantity threshold and/or greater than or equal to a second quantity threshold.

Optionally, the terminal selection request message further includes an application identity, that is, an application identity corresponding to an application of the third party terminal.

Step 604: the terminal 1 broadcasts the discovery message, where the discovery message includes an application identity; and returning, by a terminal matching the application identity in the discovery message, a response message, and then, establishing, by the terminal 1, a connection to the matching terminal.

Herein, after receiving the terminal selection request message, the terminal 1 maps the terminal selection request message into ranging service requirement information (such as a measurement distance, a measurement direction, or measurement accuracy). In order to perform a ranging process, the terminal 1 first selects, based on the application identity, a terminal having the same application as the third party terminal, to ensure that data collected by the selected terminal or inference results can be used by the third party terminal. In view of this, the terminal 1 broadcasts the discovery message, where the discovery message includes the application identity; and the terminal matching the application identity in the discovery message returns the response message, and then the terminal 1 establishes a connection to the matching terminal. For example, if terminals 2, 3, and 4 have the same application, the terminal 1 establishes connections to the terminals 2, 3, and 4.

Herein, the application identity may be at least one of an App ID, a model ID, and Prose application code.

Step 605: the terminal 1 performs a ranging process for the terminal to which the connection is established, and obtaining measurement data of each terminal.

Herein, it is assumed that the terminal 1 establishes the connections to the terminals 2, 3, and 4 in Step 604, the terminal 1 separately performs ranging processes for the terminals 2, 3, and 4 to obtain measurement data respectively corresponding to the terminals 2, 3, and 4 (such as measurement data of reference signals of the terminals 2, 3, and 4).

Herein, the terminal 1 performs, based on the ranging service requirement information, a ranging process for the terminal to which the connection is established.

Step 606: the terminal 1 calculates a ranging result corresponding to each terminal based on the measurement data of the terminal, and selecting at least one terminal based on the terminal selection policy.

Herein, it is assumed that in Step 605, the terminal 1 obtains the measurement data respectively corresponding to the terminals 2, 3, and 4, the terminal 1 calculates ranging results respectively corresponding to the terminals 2, 3, and 4 (such as distances and/or directions of the terminals 2, 3, and 4 relative to the terminal 1) based on the measurement data. The terminal 1 selects the terminals 3 and 4 based on the terminal selection policy and the ranging results respectively corresponding to the terminals 2, 3, and 4.

Step 607: the terminal 1 sends a terminal selection request reply message to the third party terminal, where the terminal selection request reply message includes a terminal identity of the at least one selected terminal.

Herein, it is assumed that the terminal 1 selects the terminals 3 and 4 in Step 606, the terminal 1 includes terminal identities of the terminals 3 and 4 in the terminal selection request reply message.

Herein, since the terminal 1 has established connections to the selected terminals (such as terminals 3 and 4), if the terminal 1 can function as a relay terminal and has been authorized to function as a relay terminal, the terminal 1 may include relay indication information (namely, the first indication information in the foregoing solution) in the terminal selection request reply message, and the relay indication information is used to indicate that the terminal 1 is configured to function as a relay terminal to help the third party terminal collect data from the selected terminals (such as terminals 3 and 4). In addition, the terminal selection request reply message may further include RSC, connection parameters of the terminals 3 and 4 (such as a user info ID and a layer-2 ID), to ensure that the third party terminal does not need to perform a discovery process of the relay terminal and can directly use an established link to perform relay communication with the terminals 3 and 4.

Step 608: the third party terminal communicates with the selected terminal through the terminal 1.

Herein, the third party terminal uses a link modification process to establish connections to the terminals 3 and 4 respectively through the terminal 1 based on the terminal identities of the terminals 3 and 4 selected in Step 607, the relay indication information, and the connection parameters of the terminals 3 and 4.

Optionally, in addition to the terminal identity of the at least one terminal, an application layer of the third party terminal may finally determine the selected terminals based on other application information, such as computing power, power, and other non-communication layer information of the terminals 3 and 4. For example, the third party terminal finally determines to select the terminals 3 and 4 for federated inference.

Through the foregoing application instance, the third party terminal sends the terminal selection policy to the terminal 1, to ensure that the terminal 1 provides a terminal identity that satisfies the terminal selection policy to the third party terminal, without needing to provide a ranging result for the third party terminal, thereby reducing signaling overheads, and also ensuring security because a large quantity of ranging results are not exposed to a third party.

### Application Instance 2

The third party terminal shown in the federated inference scenario in FIG. 1 may further be a third party server, that is, in order to accurately identify the terminal 1, the third party server needs to select other terminals around the terminal 1 to collect data. Therefore, in this application instance, the third party server needs to perform terminal selection with the help of a core network. This generally includes the following two stages.

Stage 1: The third party server first sends a terminal selection request message to the first core network element through the AF. The terminal selection request message includes a terminal selection policy, a reference terminal identity (namely, the terminal identity of the terminal 1) and other terminal identities. The other terminal identities may be a series of terminal identities of the other terminals around the terminal 1, or may be a group identity corresponding to the other terminals around the terminal 1. The third party server provides other terminal identities to ensure that these terminals have applications required for federated inference. After receiving the terminal selection request message, the first core network element maps the terminal selection request message into ranging service requirement information. The first core network element sends a ranging request message to an AMF that serves the terminal 1, where the ranging request message includes ranging service requirement information, a reference terminal identity, and other terminal identities. The AMF sends the ranging request message to the terminal 1 through a non-access stratum (NAS) message. The terminal 1 establishes connections to other terminals respectively based on the other terminal identities, performs ranging processes for the other terminals based on the ranging service requirement information, and obtains ranging results corresponding to the other terminals (such as positions and/or directions of the other terminals relative to the terminal 1). The UE1 sends the ranging results to the AMF, and the AMF sends the ranging results to the first core network element. The first core network element selects at least one terminal based on the terminal selection policy and the ranging results, feeds back the terminal identity of the at least one selected terminal to the AF through a terminal selection request reply message, and then feeds back the terminal identity to the third party server.

Stage 2: The third party server communicates with the at least one selected terminal, and collects information about the UE1 from the at least one terminal.

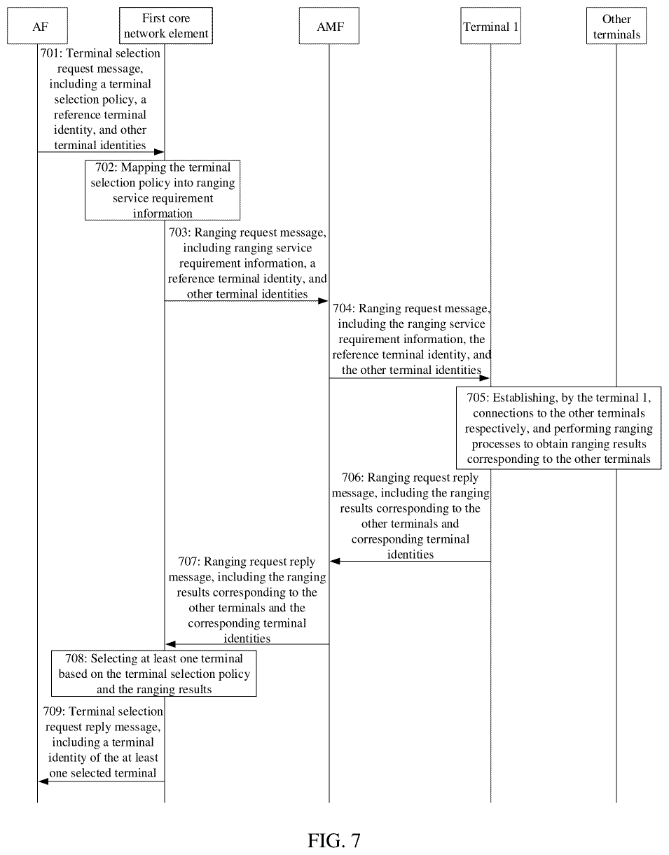

FIG. 7 shows a specific process of this application instance (where the third party server is omitted in FIG. 7. The third party server interacts with the core network through the AF. Operations performed by the AF may be understood as operations performed by the third party server). The specific process includes the following steps.

Step 701: the AF sends a terminal selection request message to the first core network element. The terminal selection request message includes a terminal selection policy, a reference terminal identity (namely, the terminal identity of the terminal 1), and other terminal identities.

Herein, the other terminal identities may be a series of terminal identities of the other terminals around the terminal 1, or may be a group identity corresponding to the other terminals around the terminal 1. The AF provides other terminal identities to ensure that these terminals have applications required for federated inference.

The terminal selection request message includes the terminal selection policy, and the terminal selection policy includes at least one of the following: a first selection policy, where the first selection policy is used to indicate selection of a terminal whose distance from the terminal 1 is less than or equal to a first distance threshold; a second selection policy, where the second selection policy is used to indicate at least one of the following: selection of terminals located in different directions of the terminal 1, or selection of terminals located in a plurality of directions specified by the terminal 1; or a third selection policy, where the third selection policy is used to indicate at least one of the following: a quantity of selected terminals, or a quantity of selected terminals being less than or equal to a first quantity threshold and/or greater than or equal to a second quantity threshold.

Step 702: the first core network element maps the terminal selection policy into ranging service requirement information.

Herein, after receiving the terminal selection request message, the first core network element maps the terminal selection request message into ranging service requirement information (such as a measurement distance, a measurement direction, or measurement accuracy).

Step 703: the first core network element sends a ranging request message to the AMF that serves the terminal 1, where the ranging request message includes ranging service requirement information, a reference terminal identity (namely, the terminal identity of the terminal 1), and other terminal identities.

Herein, the ranging service requirement information includes a measurement distance, a measurement direction, measurement accuracy, and the like.

Step 704: the AMF sends a ranging request message to the terminal 1 by using a NAS message. The ranging request message includes ranging service requirement information, a reference terminal identity (namely, the terminal identity of the terminal 1), and other terminal identities.

Herein, the ranging service requirement information includes a measurement distance, a measurement direction, measurement accuracy, and the like.

Step 705: the terminal 1 establishes connections to other terminals respectively, and performing ranging processes to obtain ranging results corresponding to the other terminals.

Step 706: the terminal 1 sends a ranging request reply message to the AMF, where the ranging request reply message includes the ranging results corresponding to the other terminals and corresponding terminal identities.

Step 707: the AMF sends the ranging request reply message to the first core network element, where the ranging request reply message includes the ranging results corresponding to the other terminals and the corresponding terminal identities.

Step 708: the first core network element selects at least one terminal based on the terminal selection policy and the ranging results.

Step 709: the first core network element sends a terminal selection request reply message to the AF, where the terminal selection request reply message includes a terminal identity of the at least one selected terminal.

The foregoing describes in detail the preferred implementations of this application with reference to the accompanying drawings. However, this application is not limited to specific details in the foregoing implementation. Within the scope of the technical concepts of this application, various simple variations may be implemented to the technical solutions in this application, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may alternatively be performed between different implementations of this application, provided that the combination is not contrary to the idea of this application, and the combination shall also be considered as the content disclosed in this application. For another example, without conflicts, embodiments described in this application and/or the technical features in embodiments may be randomly combined with the prior art, and the technical solutions obtained after the combination also fall within the protection scope of this application.

It should be further understood that, in the method embodiments of this application, sequence numbers of the foregoing processes do not mean execution sequences. The execution sequences of the processes shall be determined based on functions and internal logic of the processes, and shall not be construed as any limitation on the implementation processes of embodiments of this application. In addition, in embodiments of this application, the terms “downlink”, “uplink”, and “sidelink” are used to indicate a transmission direction of a signal or data, where “downlink” indicates that a transmission direction of a signal or data is a first direction from a station to user equipment in a cell, “uplink” indicates that a transmission direction of a signal or data is a second direction from user equipment in a cell to a station, and “sidelink” indicates that a transmission direction of a signal or data is a third direction from user equipment 1 to user equipment 2. For example, a “downlink signal” indicates that a transmission direction of the signal is a first direction. In addition, in embodiments of this application, the term “and/or” is merely used to describe an association relationship between associated objects, and represents that there may be three relationships. Specifically, “A and/or B” may indicate the following three cases: Only A exists, both A and B exist, and only B exists. In addition, the character “/” in this specification generally indicates an “or” relationship between the associated objects.

FIG. 8 is a schematic diagram 1 of a structure of a terminal selection apparatus according to an embodiment of this application. The terminal selection apparatus is applied to a first node. As shown in FIG. 8, the terminal selection apparatus includes: a communications unit 801, configured to receive a first request message sent by a second node, where the first request message includes a terminal selection policy, and the first request message is used to trigger a first terminal to perform ranging processes for a plurality of terminals, to obtain ranging results corresponding to the plurality of terminals; and a selection unit 802, configured to select at least one terminal from the plurality of terminals based on the ranging results corresponding to the plurality of terminals and the terminal selection policy, where the communications unit 801 is further configured to send a first request reply message to the second node, where the first request reply message includes a terminal identity of the at least one terminal.

In some implementations, the terminal selection policy includes at least one of the following: a first selection policy, where the first selection policy is used to indicate selection of a terminal whose distance from the first terminal is less than or equal to a first distance threshold; a second selection policy, where the second selection policy is used to indicate at least one of the following: selection of terminals located in different directions of the first terminal, or selection of terminals located in a plurality of directions specified by the first terminal; or a third selection policy, where the third selection policy is used to indicate at least one of the following: a quantity of selected terminals, or a quantity of selected terminals being less than or equal to a first quantity threshold and/or greater than or equal to a second quantity threshold.

In some implementations, the first node is the first terminal, and the second node is a third party terminal; and the communications unit 801 is configured to receive a first request message sent by the third party terminal, and send a first request reply message to the third party terminal.

In some implementations, the apparatus further includes: a determining unit 803, configured to determine ranging service requirement information based on the first request message; and the communications unit 801 is configured to perform ranging processes for a plurality of terminals based on the ranging service requirement information, to obtain ranging results corresponding to the plurality of terminals.

In some implementations, the first request message further includes an application identity. The determining unit 803 is configured to determine, based on the application identity, a plurality of terminals each having a target application, where the application identity is used to identify the target application. The communications unit 801 is configured to establish connections to the plurality of terminals.

In some implementations, the communications unit 801 is configured to broadcast a first discovery message, where the first discovery message includes the application identity. The determining unit 803 is configured to determine, based on a first response message received by the communications unit 801, a plurality of terminals each having the target application, where the first response message is sent, after the first discovery message is received, by a terminal having the target application identified by the application identity.

In some implementations, the first request reply message further includes first indication information and/or a connection parameter of the at least one terminal, the first indication information is used to indicate that the first terminal is configured to function as a relay terminal, and the connection parameter of the at least one terminal is used for relay communication between the third party terminal and the at least one terminal.

In some implementations, the communications unit 801 is configured to establish a connection to the third party terminal.

In some implementations, the communications unit 801 is configured to: broadcast a second discovery message, where the second discovery message includes second indication information and/or a first parameter, the second indication information is used to indicate that the first terminal supports ranging, and the first parameter includes a terminal identity list that is used to indicate a list of terminals on which the first terminal is configured to perform a ranging process; and accept connection establishment requested by the 3^{rd} party terminal based on the second discovery message.

In some implementations, the first node is a first core network element, and the second node is a third party server; and the communications unit 801 is configured to receive a first request message sent by the third party server, and send a first request reply message to the third party server.

In some implementations, the determining unit 803 is configured to determine ranging service requirement information based on the first request message; and the communications unit 801 is configured to: directly or indirectly send a ranging request message to the first terminal, where the ranging request message includes the ranging service requirement information, and the ranging service requirement information is used to trigger the first terminal to perform the ranging processes for the plurality of terminals, to obtain the ranging results corresponding to the plurality of terminals; and directly or indirectly receive a ranging request reply message sent by the first terminal, where the ranging request reply message includes the ranging results corresponding to the plurality of terminals.

In some implementations, the communications unit 801 is configured to send the ranging request message to the first terminal via forwarding by a second core network element, and receive the ranging request reply message from the first terminal and forwarded by the second core network element.

In some implementations, the first request message further includes first identity information and/or second identity information, and the ranging request message further includes first identity information and/or second identity information; the first identity information is used to identify that a reference terminal for performing the ranging processes is the first terminal; and the second identity information is used to identify that target terminals on which the ranging processes are performed are the plurality of terminals.

In some implementations, the first identity information is a terminal identity of the first terminal.

In some implementations, the second identity information includes terminal identities of the plurality of terminals; or the second identity information is a group identity corresponding to the plurality of terminals.

In some implementations, the plurality of terminals identified by the second identity information have a target application.

In some implementations, the ranging service requirement information includes at least one of following: a measurement distance, a measurement direction, or measurement accuracy.

In some implementations, the ranging results include at least one of following: a distance of a terminal relative to the first terminal, or a direction of the terminal relative to the first terminal.

A person skilled in the art should understand that related descriptions of the foregoing terminal selection apparatuses in embodiments of this application may be understood with reference to related descriptions of the terminal selection methods in embodiments of this application.

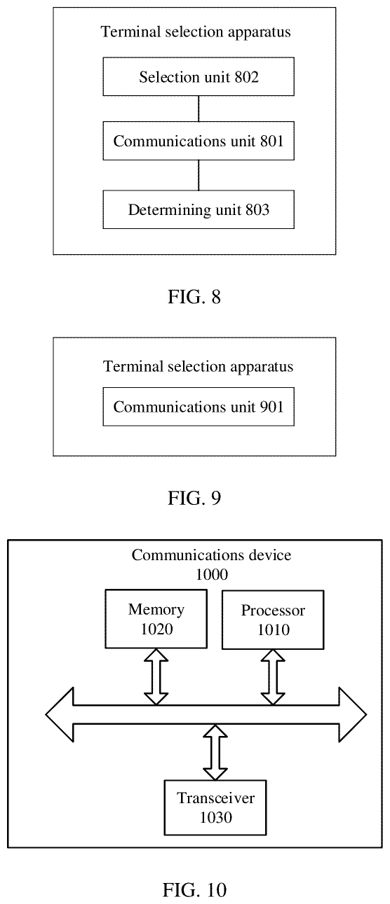

FIG. 9 is a schematic diagram 2 of a structure of a terminal selection apparatus according to an embodiment of this application. The terminal selection apparatus is applied to a second node. As shown in FIG. 9, the terminal selection apparatus includes: a communications unit 901, configured to: send a first request message to a first node, where the first request message includes a terminal selection policy, the first request message is used to trigger a first terminal to perform ranging processes for a plurality of terminals, to obtain ranging results corresponding to the plurality of terminals, and the terminal selection policy is used by the first node to select at least one terminal from the plurality of terminals based on the ranging results corresponding to the plurality of terminals; and receive a first request reply message sent by the first node, where the first request reply message includes a terminal identity of the at least one terminal.

In some implementations, the terminal selection policy includes at least one of the following: a first selection policy, where the first selection policy is used to indicate selection of a terminal whose distance from the first terminal is less than or equal to a first distance threshold; a second selection policy, where the second selection policy is used to indicate at least one of the following: selection of terminals located in different directions of the first terminal, or selection of terminals located in a plurality of directions specified by the first terminal; or a third selection policy, where the third selection policy is used to indicate at least one of the following: a quantity of selected terminals, or a quantity of selected terminals being less than or equal to a first quantity threshold and/or greater than or equal to a second quantity threshold.

In some implementations, the first node is the first terminal, and the second node is a third party terminal; and the communications unit 901 is configured to send a first request message to the first terminal, and receive a first request reply message sent by the first terminal.

In some implementations, the first request message further includes an application identity, the application identity is used by the first terminal to determine a plurality of terminals each having a target application, and the application identity is used to identify the target application.

In some implementations, the first request reply message further includes first indication information and/or a connection parameter of the at least one terminal, the first indication information is used to indicate that the first terminal is configured to function as a relay terminal, and the connection parameter of the at least one terminal is used for relay communication between the third party terminal and the at least one terminal.

In some implementations, the communications unit 901 is further configured to establish a connection to the first terminal.

In some implementations, the communications unit 901 is configured to: receive a second discovery message broadcast by the first terminal, where the second discovery message includes second indication information and/or a first parameter, the second indication information is used to indicate that the first terminal supports ranging, and the first parameter includes a terminal identity list that is used to indicate a list of terminals on which the first terminal is configured to perform a ranging process; and select the first terminal based on the second discovery message, and request establishment of a connection to the first terminal.

In some implementations, the first node is a first core network element, and the second node is a third party server; and the communications unit 901 is configured to send a first request message to the first core network element, and receive a first request reply message sent by the first core network element.

In some implementations, the first request message further includes first identity information and/or second identity information; the first identity information is used to identify that a reference terminal for performing the ranging processes is the first terminal; and the second identity information is used to identify that target terminals on which the ranging processes are performed are the plurality of terminals.

In some implementations, the first identity information is a terminal identity of the first terminal.

In some implementations, the second identity information includes terminal identities of the plurality of terminals; or the second identity information is a group identity corresponding to the plurality of terminals.

In some implementations, the plurality of terminals identified by the second identity information have a target application.

In some implementations, the ranging results include at least one of following: a distance of a terminal relative to the first terminal, or a direction of the terminal relative to the first terminal.

A person skilled in the art should understand that related descriptions of the foregoing terminal selection apparatuses in embodiments of this application may be understood with reference to related descriptions of the terminal selection methods in embodiments of this application.

FIG. 10 is a schematic diagram of a structure of a communications device 1000 according to an embodiment of this application. The communications device may be a first node, or may be a second node. The communications device 1000 shown in FIG. 10 includes a processor 1010, and the processor 1010 may invoke a computer program from a memory and run the computer program to implement a method in embodiments of this application.

As shown in FIG. 10, the communications device 1000 may further include a memory 1020. The processor 1010 may invoke and run a computer program in the memory 1020, to implement a method in embodiments of this application.

The memory 1020 may be a separate component independent of the processor 1010, or may be integrated into the processor 1010.

Optionally, as shown in FIG. 10, the communications device 1000 may further include a transceiver 1030. The processor 1010 may control the transceiver 1030 to communicate with another device, and specifically, may transmit information or data to the another device, or receive information or data transmitted by the another device.

The transceiver 1030 may include a transmitter and a receiver. The transceiver 1030 may further include an antenna. There may be one or more antennas.

Optionally, the communications device 1000 may be specifically the first node in embodiments of this application, and the communications device 1000 may implement corresponding processes implemented by the first node in methods in embodiments of this application. For brevity, details are not described herein again.

Optionally, the communications device 1000 may be specifically the second node in embodiments of this application, and the communications device 1000 may implement corresponding processes implemented by the second node in methods in embodiments of this application. For brevity, details are not described herein again.

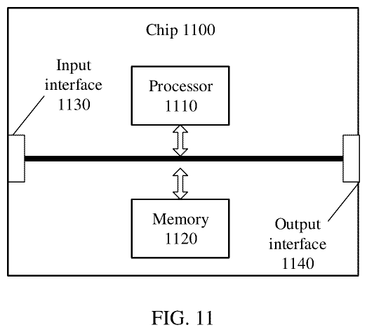

FIG. 11 is a schematic diagram of a structure of a chip according to an embodiment of this application. The chip 1100 shown in FIG. 11 includes a processor 1110, and the processor 1110 may invoke a computer program from a memory and run the computer program to implement a method in embodiments of this application.

Optionally, as shown in FIG. 11, the chip 1100 may further include a memory 1120.

The processor 1110 may invoke a computer program from the memory 1120 and run the computer program to implement a method in embodiments of this application.

The memory 1120 may be a separate component independent of the processor 1110, or may be integrated into the processor 1110.

Optionally, the chip 1100 may further include an input interface 1130. The processor 1110 may control the input interface 1130 to communicate with another device or chip, and specifically, may obtain information or data transmitted by the another device or chip.

Optionally, the chip 1100 may further include an output interface 1140. The processor 1110 may control the output interface 1140 to communicate with another device or chip, and specifically, may output information or data to the another device or chip.

Optionally, the chip may be applied to the first node in embodiments of this application, and the chip may implement corresponding processes implemented by the first node in methods in embodiments of this application. For brevity, details are not described herein again.

Optionally, the chip may be applied to the second node in embodiments of this application, and the chip may implement corresponding processes implemented by the second node in methods in embodiments of this application. For brevity, details are not described herein again.

It should be understood that the chip mentioned in embodiments of this application may also be referred to as a system-level chip, a system chip, a chip system, a system-on-chip, or the like.

It should be understood that a processor in this embodiment of this application may be an integrated circuit chip having a signal processing capability. In an implementation process, the steps in the foregoing method embodiments can be implemented by using a hardware integrated logical circuit in the processor, or by using the instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The methods, the steps, and logical block diagrams that are disclosed in embodiments of this application may be implemented or performed. The general-purpose processor may be a microprocessor, or the processor may be any conventional processor or the like. The steps in the methods disclosed with reference to embodiments of this application may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory. The processor reads information in the memory and completes the steps of the foregoing methods in combination with hardware thereof.

It may be understood that, in embodiments of this application, the memory may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that the memories in the systems and the methods described in this specification include but are not limited to these and any memory of another appropriate type.

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), a direct rambus random access memory (Direct Rambus RAM, DR RAM), or the like. In other words, the memory in this embodiment of this application includes but is not limited to these memories and any memory of another appropriate type.

An embodiment of this application further provides a computer-readable storage medium for storing a computer program.

Optionally, the computer-readable storage medium may be applied to the first node in embodiments of this application, and the computer program causes a computer to perform corresponding processes implemented by the first node in methods in embodiments of this application. For brevity, details are not described herein again.

Optionally, the computer-readable storage medium may be applied to the second node in embodiments of this application, and the computer program causes a computer to perform corresponding processes implemented by the second node in methods in embodiments of this application. For brevity, details are not described herein again.

An embodiment of this application further provides a computer program product including computer program instructions.

Optionally, the computer program product may be applied to the first node in embodiments of this application, and the computer program instructions cause a computer to perform corresponding processes implemented by the first node in methods in embodiments of this application. For brevity, details are not described herein again.

Optionally, the computer program product may be applied to the second node in embodiments of this application, and the computer program instructions cause a computer to perform corresponding processes implemented by the second node in methods in embodiments of this application. For brevity, details are not described herein again.

An embodiment of this application further provides a computer program.

Optionally, the computer program may be applied to the first node in embodiments of this application, and the computer program, when run by a computer, causes the computer to perform corresponding processes implemented by the first node in methods in embodiments of this application. For brevity, details are not described herein again.

Optionally, the computer program may be applied to the second node in embodiments of this application, and the computer program, when run by a computer, causes the computer to perform corresponding processes implemented by the second node in methods in embodiments of this application. For brevity, details are not described herein again.

A person of ordinary skill in the field may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, reference may be made to a corresponding process in the foregoing method embodiments. Details are not described herein again.

In the several embodiments provided in this application, it should be understood that the disclosed system, apparatus, and method may be implemented in another manner. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technologies, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes various media that may store program code, such as a USB flash drive, a removable hard disk, a read-only memory (ROM), a random access memory (RAM), a magnetic disk, or an optical disk.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A terminal selection method, wherein the method comprises:
receiving, by a first node, a first request message sent by a second node, wherein the first request message comprises a terminal selection policy, and the first request message is used to trigger a first terminal to perform ranging processes for a plurality of terminals, to obtain ranging results corresponding to the plurality of terminals;
selecting, by the first node, at least one terminal from the plurality of terminals based on the ranging results corresponding to the plurality of terminals and the terminal selection policy; and
sending, by the first node, a first request reply message to the second node, wherein the first request reply message comprises a terminal identity of the at least one terminal.

2. The method according to claim 1, wherein the terminal selection policy comprises at least one of following:
a first selection policy, wherein the first selection policy is used to indicate selection of a terminal whose distance from the first terminal is less than or equal to a first distance threshold;
a second selection policy, wherein the second selection policy is used to indicate at least one of the following: selection of terminals located in different directions of the first terminal, or selection of terminals located in a plurality of directions specified by the first terminal; or
a third selection policy, wherein the third selection policy is used to indicate at least one of the following: a quantity of selected terminals, or a quantity of selected terminals being less than or equal to a first quantity threshold and/or greater than or equal to a second quantity threshold.

3. The method according to claim 1, wherein after the receiving, by the first node, a first request message sent by the second node, the method further comprises:
determining, by the first node, ranging service requirement information based on the first request message; and
performing, by the first node, ranging processes for a plurality of terminals based on the ranging service requirement information, to obtain ranging results corresponding to the plurality of terminals.

4. The method according to claim 3, wherein the first request message further comprises an application identity, and before the performing, by the first node, ranging processes for a plurality of terminals based on the ranging service requirement information, the method further comprises:
determining, by the first node based on the application identity, a plurality of terminals each having a target application, wherein the application identity is used to identify the target application; and
establishing, by the first node, connections to the plurality of terminals.

5. The method according to claim 4, wherein the determining, by the first node based on the application identity, a plurality of terminals each having a target application comprises:
broadcasting, by the first node, a first discovery message, wherein the first discovery message comprises the application identity; and
determining, by the first node based on a received first response message, a plurality of terminals each having the target application, wherein the first response message is sent, after the first discovery message is received, by a terminal having the target application identified by the application identity.

6. The method according to claim 1, wherein the first request reply message further comprises first indication information and/or a connection parameter of the at least one terminal, the first indication information is used to indicate that the first terminal is configured to function as a relay terminal, and the connection parameter of the at least one terminal is used for relay communication between the second node and the at least one terminal.

7. The method according to claim 1, wherein before the receiving, by the first node, a first request message sent by the second node, the method further comprises:
establishing, by the first node, a connection to the second node, wherein the establishing, by the first node, a connection to the second node comprises:
broadcasting, by the first node, a second discovery message, wherein the second discovery message comprises second indication information and/or a first parameter, the second indication information is used to indicate that the first node supports ranging, and the first parameter comprises a terminal identity list that is used to indicate a list of terminals on which the first terminal is configured to perform a ranging process; and
accepting, by the first node, connection establishment requested by the second node based on the second discovery message.

8. The method according to claim 1, wherein after the receiving, by the first node, a first request message sent by the second node, the method further comprises:
determining, by the first node, ranging service requirement information based on the first request message;
directly or indirectly sending, by the first node, a ranging request message to the first terminal, wherein the ranging request message comprises the ranging service requirement information, and the ranging service requirement information is used to trigger the first terminal to perform the ranging processes for the plurality of terminals, to obtain the ranging results corresponding to the plurality of terminals; and
directly or indirectly receiving, by the first node, a ranging request reply message sent by the first terminal, wherein the ranging request reply message comprises the ranging results corresponding to the plurality of terminals.

9. A communications device, comprising a processor and a memory, wherein the memory is configured to store a computer program, and the processor is configured to invoke and run the computer program stored in the memory to perform:
receiving a first request message sent by a second node, wherein the first request message comprises a terminal selection policy, and the first request message is used to trigger a first terminal to perform ranging processes for a plurality of terminals, to obtain ranging results corresponding to the plurality of terminals;
selecting at least one terminal from the plurality of terminals based on the ranging results corresponding to the plurality of terminals and the terminal selection policy; and
sending a first request reply message to the second node, wherein the first request reply message comprises a terminal identity of the at least one terminal.

10. The communications device according to claim 9, wherein the terminal selection policy comprises at least one of following:
a first selection policy, wherein the first selection policy is used to indicate selection of a terminal whose distance from the first terminal is less than or equal to a first distance threshold;
a second selection policy, wherein the second selection policy is used to indicate at least one of the following: selection of terminals located in different directions of the first terminal, or selection of terminals located in a plurality of directions specified by the first terminal; or
a third selection policy, wherein the third selection policy is used to indicate at least one of the following: a quantity of selected terminals, or a quantity of selected terminals being less than or equal to a first quantity threshold and/or greater than or equal to a second quantity threshold.

11. The communications device according to claim 9, wherein after the receiving a first request message sent by the second node, the processor is configured to invoke and run the computer program stored in the memory to further perform:
determining ranging service requirement information based on the first request message; and
performing ranging processes for a plurality of terminals based on the ranging service requirement information, to obtain ranging results corresponding to the plurality of terminals.

12. The communications device according to claim 11, wherein the first request message further comprises an application identity, and before the performing ranging processes for a plurality of terminals based on the ranging service requirement information, the processor is configured to invoke and run the computer program stored in the memory to further perform:
determining, based on the application identity, a plurality of terminals each having a target application, wherein the application identity is used to identify the target application; and
establishing connections to the plurality of terminals.

13. The communications device according to claim 12, wherein the determining, based on the application identity, a plurality of terminals each having a target application comprises:
broadcasting a first discovery message, wherein the first discovery message comprises the application identity; and
determining, based on a received first response message, a plurality of terminals each having the target application, wherein the first response message is sent, after the first discovery message is received, by a terminal having the target application identified by the application identity.

14. The communications device according to claim 9, wherein the first request reply message further comprises first indication information and/or a connection parameter of the at least one terminal, the first indication information is used to indicate that the first terminal is configured to function as a relay terminal, and the connection parameter of the at least one terminal is used for relay communication between the second node and the at least one terminal.

15. The communications device according to claim 9, wherein before the receiving a first request message sent by the second node, the processor is configured to invoke and run the computer program stored in the memory to further perform:
establishing a connection to the second node, wherein the establishing a connection to the second node comprises:
broadcasting a second discovery message, wherein the second discovery message comprises second indication information and/or a first parameter, the second indication information is used to indicate that the communications device supports ranging, and the first parameter comprises a terminal identity list that is used to indicate a list of terminals on which the first terminal is configured to perform a ranging process; and
accepting connection establishment requested by the second node based on the second discovery message.

16. A communications device, comprising a processor and a memory, wherein the memory is configured to store a computer program, and the processor is configured to invoke and run the computer program stored in the memory to perform:
sending a first request message to a first node, wherein the first request message comprises a terminal selection policy, the first request message is used to trigger a first terminal to perform ranging processes for a plurality of terminals, to obtain ranging results corresponding to the plurality of terminals, and the terminal selection policy is used by the first node to select at least one terminal from the plurality of terminals based on the ranging results corresponding to the plurality of terminals; and
receiving a first request reply message sent by the first node, wherein the first request reply message comprises a terminal identity of the at least one terminal.

17. The communications device according to claim 16, wherein the terminal selection policy comprises at least one of following:
a first selection policy, wherein the first selection policy is used to indicate selection of a terminal whose distance from the first terminal is less than or equal to a first distance threshold;
a second selection policy, wherein the second selection policy is used to indicate at least one of the following: selection of terminals located in different directions of the first terminal, or selection of terminals located in a plurality of directions specified by the first terminal; or
a third selection policy, wherein the third selection policy is used to indicate at least one of the following: a quantity of selected terminals, or a quantity of selected terminals being less than or equal to a first quantity threshold and/or greater than or equal to a second quantity threshold.

18. The communications device according to claim 16, wherein the first request message further comprises an application identity, the application identity is used by the first terminal to determine a plurality of terminals each having a target application, and the application identity is used to identify the target application.

19. The communications device according to claim 16, wherein the first request reply message further comprises first indication information and/or a connection parameter of the at least one terminal, the first indication information is used to indicate that the first terminal is configured to function as a relay terminal, and the connection parameter of the at least one terminal is used for relay communication between the communications device and the at least one terminal.

20. The communications device according to claim 16, wherein before the sending a first request message to the first node, the processor is configured to invoke and run the computer program stored in the memory to further perform:
establishing a connection to the first terminal, wherein the establishing a connection to the first terminal comprises:
receiving a second discovery message broadcast by the first terminal, wherein the second discovery message comprises second indication information and/or a first parameter, the second indication information is used to indicate that the first terminal supports ranging, and the first parameter comprises a terminal identity list that is used to indicate a list of terminals on which the first terminal is configured to perform a ranging process; and
selecting the first terminal based on the second discovery message, and requesting establishment of a connection to the first terminal.
